(19) United States
(12) Patent Application Publication
(10) Pub. No.: US 2005/0275731 A1
(43) Pub. Date: Dec. 15, 2005

(54) Method and apparatus for generating frames and sound effects for digital cameras by using computer-compatible files

(75) Inventor: Yi-Ta Chianglin, Hsin Chu (TW)

Correspondence Address: TROXELL LAW OFFICE PLLC, 5205 LEESBURG PIKE, SUITE 1404, FALLS CHURCH, VA, 22041, US

(73) Assignee: Premier Image Technology Corporation

(21) Appl. No.: 10/863,214

(22) Filed: Jun. 9, 2004

(51) Int. Cl. G06F 7/00; G06F 17/30; H04N 5/76; H04N 5/262; G03B 17/24

(52) U.S. Cl. 348/231.4; 348/239; 396/312

(57) ABSTRACT

A method and apparatus for generating frames and sound effects of digital cameras by using computer-compatible files is described. By using the same, digital cameras will play the frames and sound effects selected by users when turned on or off, standing by and entering selection lists. The image files and the sound-effect files played by the digital cameras have the same formats as computer files, which effectively increases the compatibility and expandability of the digital cameras so as to provide more perfect and interesting functions to the users.

### BACKGROUND OF THE INVENTION

1. Field of the Invention

The present invention provides a method and apparatus for generating frames and sound effects for digital cameras by using computer-compatible files, and particularly, to a method and apparatus for providing image files and sound-effect files compatible with computers so that the users can select and set the frames and sound effects to be played when the digital cameras are turned on, turned off, standing by or entering selection lists.

2. Description of the Prior Art

As the digital era is coming and the relevant hardware and software technology is being vigorously developed, various digital devices are more popular and commonly used in daily life. In addition to the demand of being small in volume, light in weight and cheap, digital devices must also have more powerful and complete application functions, providing users with more pleasures. In order to meet the various demands from the market, manufactures are struggling to develop new products with the most advanced and appealing functions. Therefore, various digital devices with different uses are popular and common in the everyday life.

The digital still camera is one of the most popular digital products. The main difference between the digital camera and the traditional camera is that images taken by the digital camera are easily edited. In the digital camera, software used to compose, modify or delete the pictures, providing practicability and convenience. Therefore, the popularity of the digital camera is greatly increased, and even professional photographers are gradually beginning to use digital cameras. Furthermore, the digital cameras are provided with powerful additional functions, providing users with more pleasure and entertainment.

In the present market, liquid crystal screens are installed on the available digital cameras for showing the size, distance, brightness and resolution of the photographic subject to a user, which provides practicability and convenience. However, with regard to entertainment, there is much room for advancement.

For example, in the common digital cameras, the frames for starting or shutting-down are built-in, and therefore, the frames for starting or shutting-down displayed on the liquid crystal screens are fixed, which provides no options for a user to select a favorite frame or sound effects to be played when the digital cameras are turned on or off. Apparently, it is dull for the users, and it is because the file formats to be processed by the digital cameras are limited and the digital cameras cannot process the sub-filename compatible with the computer format, making the digital cameras lack expandability.

In the prior art, mobile phone manufactures provide a method for displaying frames for turning a mobile phone on or off. However, the method applied in the mobile phone is deficient. For example, the image file with high number of pixels cannot be completely stored in the mobile phone as a screen background, and even if the image file can be used, a cutting edge appears due to the different resolutions. More importantly, the sound-effect device of the present mobile phone only can play back MIDI files (music files), and does not support WAV files (sound-effect files), MP3 files and AVI files (audio-video-interleaved files). Accordingly, the mobile phones cannot process the sub-filename compatible with the computer format, which creates inconvenience for users when using mobile phones.

Therefore, in order to overcome the drawbacks of the prior art digital cameras, which cannot process computer-compatible files, the present invention relates a method and apparatus for generating frames and sound effects of digital cameras by using computer-compatible files so as to provide the user with more convenience and entertainment.

### SUMMARY OF THE INVENTION

The present invention provides a method and apparatus for generating frames and sound effects of digital cameras by using computer-compatible files. By providing computer-compatible image files and sound effect files, a user can select and set the frames and sound effects to be played when a digital camera is turned on or off, standing by or entering selection lists. The method comprises the steps of a) reading at least one data file of at least one external device; b) storing the data file in the data storage area; c) compressing the data file; and d) storing the data file in a specified position of the memory unit so that the data file being used when the digital camera is turned on or off, standing by or entering a selection list. Accordingly, the compatibility and expandability of the digital camera will be effectively increased so as to provide greater pleasure to the user.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a digital camera according to the present invention;

FIG. 2 is a block diagram of the inside circuit of the digital camera according to the present invention; and

FIG. 3 is a flowchart of a method according to the present invention.

### DETAILED DESCRIPTION OF THE PREFERRED EMBODIMENT

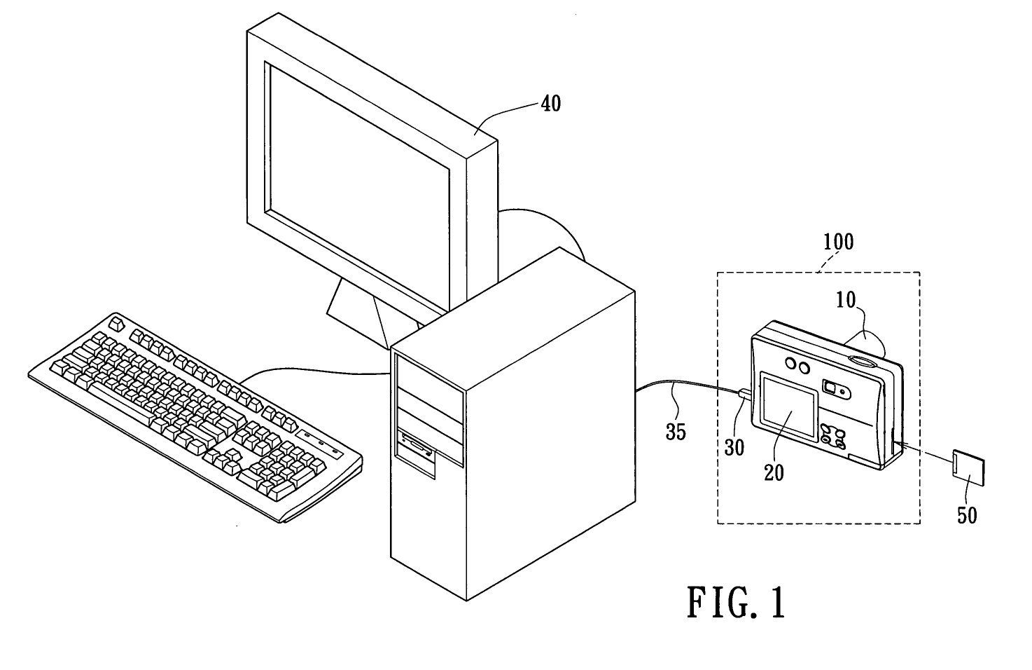

The present invention relates to a digital camera capable of processing the computer-compatible file formats so that the digital camera can play back the user's favorite frames and sound effects when turned on or off, standing by, and entering the selection list. Reference is made to FIG. 1. FIG. 1 is a perspective diagram of a digital camera 100 according to the present invention. The digital camera 100 uses an image input unit 10 for accessing the external image signals and then forming a photographic image on a display unit 20.

The data file composed of the image signals can be transmitted to an external storage device, such as a computer 40, via a connecting interface 30 and a connecting line 35. The computer 40 has the function of editing the data file, and therefore, the user can edit or modify the pictures. When the computer 40 is not available, the data files can be temporarily stored in an external memory card 50 (or a built-in one). Then, when the computer 40 is available, the data files temporarily stored in the memory card will be transmitted to the computer 40 for storage.

Similarly, the computer 40 and the memory card 50 also can transmit the edited or stored data files to a memory unit inside the digital camera 100 for storage. Therefore, the display unit 20 can play back the data file edited by the user when the digital camera 100 is turned on or off, standing by, or entering the selection list.

For example, the data file transmitted from the computer 40 or the memory card 50 can be an image file or a sound-effect file. The data file will be compressed and decompressed in the file format compatible with the computer 40, and then be stored in the memory unit of the digital camera 100 (the details will be described later) so as to be played back when the digital camera 100 is turned on or off, standing by and entering the selection list. Therefore, the cutting edge or the improper resolution will not appear when the digital camera 100 plays back the read image file on the display unit 20. This is because the digital camera 100 uses the compression technology compatible with the file format of computer 40. In contrast, the prior art can only use the specific file format incompatible with the computer.

Furthermore, the sub-filenames of the image file and the sound-effect file use file formats compatible with the computer 40. The image file can be a dot matrix image file, and the sub-filename of the dot matrix image file can be the commonly used JPG file, GIF file or BMP file. The sound-effect file can be a WAV file or a MIDI file. However, in practical application, the used sub-filename must match the design of the actual device, and is not limited to the disclosed embodiment. For example, the image file can further comprise an animation file, which may be an AVI file or a MPEG file.

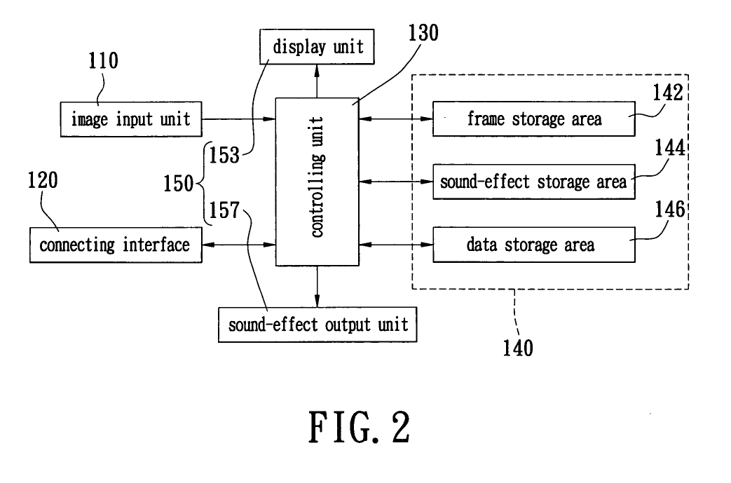

Reference is made to FIG. 2. FIG. 2 is a block diagram of the inside circuit of the digital camera 100 according to the present invention. The controlling unit 130 is connected to the image input unit 110 and the connecting interface 120 for reading the image signals accessed by the image input unit 110, or is connected to an external device (such as a computer 40 or a memory card 50) via a connecting interface 120 for decompressing the data file transmitted from the external device so that the digital camera 100 can play back the data file. Then, the data file is transmitted to a memory unit 140 for storage.

The memory unit 140 further comprises a data storage area 146, a sound-effect storage area 144 and a frame storage area 142. First, the controlling unit 144 stores the data file in the data storage area 146. At this time, the user can use an output unit 150 to preview the data file as to determine whether the data file is the file required by the user. If the data file is not the file required by the user, then the data files of the external device and the image input unit 110 are re-read until the data file is the file required by the user. If the data file is the file required by the user, then the data file is edited to the length or size required by the user so as to prevent the file from having too much content. Then, the portion relating to the image file in the data file is transmitted to the frame storage area 142 for storage, and the portion relating to the sound-effect file is transmitted to the sound-effect storage area 144 for storage.

Each of the frame storage area 142 and the sound-effect storage area 144 comprises a starting data area, a shutting-down data area, a standing-by data area and a selection-list data area (not shown) for storage the user's favorite image files and sound-effect files. Therefore, the digital camera 100 will play back these files when it is turned on or off, standing by and entering the selection list. The starting data area in the frame storage area 142 is used for storing the image file to be played back by display unit 153 in the output unit 150 when the digital camera 100 is starting. Similarly, the shutting-down, standing-by and selection-list data areas are separately used for storing the image file to be played back by the display unit 153 when the digital camera 100 is turned off, standing by and entering the selection list. Accordingly, the digital camera will play back the images or animation selected and set by the user.

Similarly, the turn on and off, standby and selection-list data areas in the sound-effect storage area 144 are separately used for storing the sound-effect files to be played back by the sound-effect output unit 157 in the output unit 150 when the digital camera 100 is turned on or off, standing by and entering the selection list. This provides the user with more pleasure when using the digital camera 100.

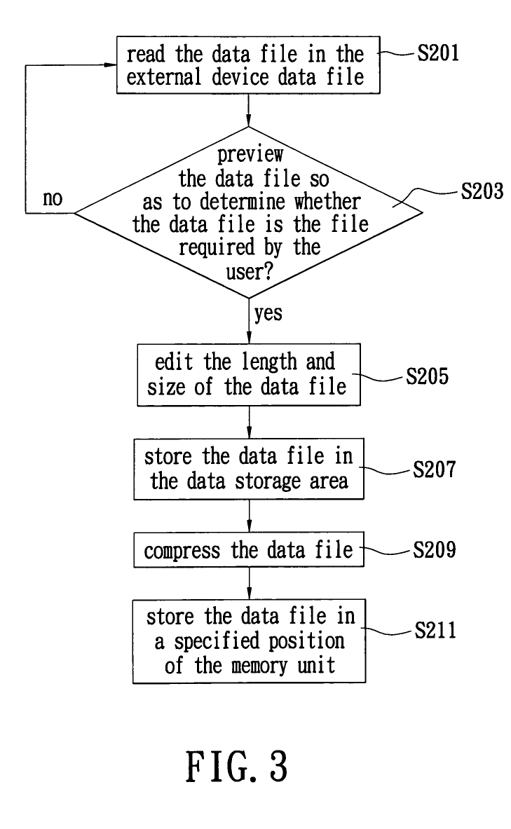

Reference is made to FIG. 3. FIG. 3 is a flowchart of a method according to the present invention. First, the data file in the external device data file is read (S201), and then the data file is decompressed so the digital camera 100 can play back the decompressed data file having the file format compatible with the computer. At this time, the output unit 150 is used for previewing the data file so as to determine whether the data file is the file required by the user (S203). If the data file is the file required by the user, then the data file is edited to the length or size required by the user (S205). If the data file is not the file required by the user, then the data file of the external device is re-read until the data file is the file required by the user.

Then, the data file is stored in the data storage area 146 (S207), and the data file is compressed (S209). The compression ratio of the image file is the highest ratio acceptable to the digital camera 100, and the sound-effect file is compressed to the lowest compression ratio acceptable to the digital camera 100. Finally, the data file is stored in a specified position of the memory unit 140 (S211) to be used when the digital camera is turned on or off, standing by or entering the selection list.

In summary, in the method and apparatus for generating frames and sound effects of digital cameras by using computer-compatible files according to the present invention, the computer-compatible file formats are applied so that the digital camera 100 can play back the user's favorite frames and sound effects when turned on or off, standing by and entering the selection list. This will overcome the compatibility problem in the prior art.

Those skilled in the art will readily observe that numerous modifications and alterations of the device may be made while retaining the teachings of the invention. Accordingly, the above disclosure should be construed as limited only by the metes and bounds of the appended claims.

1. A method for generating frames and sound effects for a digital camera by using computer-compatible files, the digital camera comprising a display unit, a sound-effect output unit and a memory unit having at least one data storage area, the method comprising:
reading at least one data file of at least one external device;
storing the data file in the data storage area;
compressing the data file; and
storing the data file in a specified position of the memory unit, wherein the data file is used when the digital camera is turned on or off, standing by or entering a selection list.

2. The method for generating frames and sound effects for a digital camera by using computer-compatible files according to claim 1, wherein in the step of reading at least one data file of at least one external device, the external device is a computer or a memory card.

3. The method for generating frames and sound effects for a digital camera by using computer-compatible files according to claim 1, wherein in the step of reading at least one data file of at least one external device, a still image file, an animation file or a sound-effect file is read.

4. The method for generating frames and sound effects for a digital camera by using computer-compatible files according to claim 3, wherein the image file is a dot matrix image file.

5. The method for generating frames and sound effects for a digital camera by using computer-compatible files according to claim 4, wherein the dot matrix image file is a JPG file, a GIF file or a BMP file.

6. The method for generating frames and sound effects for a digital camera by using computer-compatible files according to claim 3, wherein the animation file is an AVI file or a MPEG file.

7. The method for generating frames and sound effects for a digital camera by using computer-compatible files according to claim 3, wherein the sound-effect file is a WAV file or a MIDI file.

8. The method for generating frames and sound effects for a digital camera by using computer-compatible files according to claim 1, wherein after the step of reading at least one data file of at least one external device, the method further comprises the steps of:
decompressing the data file of the external device, whereby the digital camera is able to play back the data file;
previewing the data file so as to determine whether the data file is a file required by a user;
editing the data file to a length or size required by the user if the data file is the file required by the user; and
re-reading the data file of the external device if the data file being is the file required by the user, until the data file is the file required by the user.

9. The method for generating frames and sound effects for a digital camera by using computer-compatible files according to claim 1, wherein in the step of compressing the data file, the image file is compressed to a highest compression ratio acceptable to the digital camera.

10. The method for generating frames and sound effects for a digital camera by using computer-compatible files according to claim 1, wherein in the step of compressing the data file, the sound-effect file is compressed to a lowest compression ratio acceptable to the digital camera.

11. The method for generating frames and sound effects for a digital camera by using computer-compatible files according to claim 1, wherein in the step of storing the data file in a specified position of the memory unit, the image file is stored in a starting data area so as to be displayed by the display unit when the digital camera is turned on.

12. The method for generating frames and sound effects for a digital camera by using computer-compatible files according to claim 1, wherein in the step of storing the data file in a specified position of the memory unit, the specified position is selected from a shut down data area, a standby data area, or a selection list data area.

13. The method for generating frames and sound effects for a digital camera by using computer-compatible files according to claim 1, wherein in the step of storing the data file, the data file is a still image file, an animation file, or a sound-effect file.

14. An apparatus for generating frames and sound effects for a digital camera by using computer-compatible files, the apparatus comprising:
an image input unit for reading at least one image signal;
a connecting interface capable of connecting to at least one external device;
a memory unit for storing at least one data file therein;
an output unit for playing back the data file; and
a controlling unit connected to the above units for controlling input and output of the units.

15. The apparatus for generating frames and sound effects for a digital camera by using computer-compatible files according to claim 14, wherein the external device is a computer or a memory card.

16. The apparatus for generating frames and sound effects for a digital camera by using computer-compatible files according to claim 14, wherein the memory unit further comprises:
a data storage area for storing the data file;
a frame storage area connected to and controlled by the controlling unit for providing the image file to be played back by the display unit; and
a sound-effect storage area connected to and controlled by the controlling unit for providing the sound-effect file to be played back by the sound-effect output unit.

17. The apparatus for generating frames and sound effects for a digital camera by using computer-compatible files according to claim 14, wherein the output unit further comprises a display unit and a sound-effect output unit.

18. The apparatus for generating frames and sound effects for a digital camera by using computer-compatible files according to claim 16, wherein the frame storage area further comprises:
a starting data area for storing an image file to be played back by the display unit when the digital camera is turned on;
a shut down data area for storing an image file to be played back by the display unit when the digital camera is turned off;
a standby data area for storing an image file to be played back by the display unit when the digital camera is standing by; and
a selection list data area for storing an image file to be played back by the display unit when the digital camera is entering the selection list.

19. The apparatus for generating frames and sound effects for a digital camera by using computer-compatible files according to claim 16, wherein the sound-effect storage area further comprises:
a starting data area for storing a sound-effect file to be played back by the sound-effect output unit when the digital camera is starting;
a shutting-down data area for storing a sound-effect file to be played back by the sound-effect output unit when the digital camera is shutting down;
a standby data area for storing a sound-effect file to be played back by the sound-effect output unit when the digital camera is standing by; and
a selection list data area for storing a sound-effect file to be played back by the sound-effect output unit when the digital camera is entering the selection list.
